(19) United States
(12) Patent Application Publication
(10) Pub. No.: US 2015/0184751 A1
(43) Pub. Date: Jul. 2, 2015

(54) FLUID SEAL ASSEMBLY WITH EXTRUDED SEALING MEMBER FOR LEAKAGE PROTECTION

(71) Applicants: Yefim Epshetsky, Shaumburg, IL (US); Alex Paykin, Buffalo Grove, IL (US); William Schaid, Elburn, IL (US); Stellario Barbera, Hilversum (NL)

(72) Inventors: Yefim Epshetsky, Shaumburg, IL (US); Alex Paykin, Buffalo Grove, IL (US); William Schaid, Elburn, IL (US); Stellario Barbera, Hilversum (NL)

(73) Assignee: AKTIEBOLAGET SKF, Goteborg (SE)

(21) Appl. No.: 14/145,788

(22) Filed: Dec. 31, 2013

(51) Int. Cl. F16J 15/34

(52) U.S. Cl. CPC F16J 15/344

(57) ABSTRACT

A seal assembly of the present invention is used for sealing a space between a housing and a rotary shaft disposed at least partially within the housing. The seal assembly includes a generally annular sealing member having a central portion and two axially-spaced apart side portions each extending generally radially from the central portion to define a generally annular groove. The assembly includes a generally annular support member disposed within the sealing member groove and configured to retain the central portion disposed generally against the other one of the shaft and the housing. The assembly eliminates problems associated with prior art designs such as static leakage of oil, clogging up the spirals with carbonized oil that negatively impact lifecycle of the fluid seals.

### FIELD OF THE INVENTION

The present invention relates generally to fluid seals for use with relatively rotatable members, such as shafts and the like.

### BACKGROUND OF THE INVENTION

Fluid seals assemblies of various types are used in numerous applications including and not limited to sealing vehicular engine crankshafts, transmission shafts, bearing lubrication systems, compressor shaft support assemblies, and the like. The fluid seal assembly is designed to retain and seal oil or grease in a predetermined location for lubricating the shaft and to prevent ingress of environmental contaminants.

Typical fluid seal assembly includes a casing unit, a flexible sealing member having a sealing lip adapted to engage against a sealing surface of a relatively rotatable member, such as the shaft. The flexible sealing member includes a body portion extending to an annular flex portion of reduced cross-sectional thickness bonded to the metal case member and located intermediate the seal lip and metal case. The purpose of this flex section is to allow the seal lip to stay in continuous, intimate contact with the shaft it is to seal despite any lack of concentricity between the relatively rotating members, e.g. the rotating shaft and the stationery engine block into which the annular metal case member is installed.

It is important to constantly retain and seal oil or grease in a predetermined location for lubrication of the shaft and to prevent ingress of environmental contaminants. There are numerous prior art seal assembly designs, which are effective to return oil or other lubricant to the sealed cavity upon rotation of the shaft. In either case, relative motion between the shaft and the seal assembly serves to “pump” the oil, grease, or other sealed fluid back into the sealed region defined between the shaft and the seal assembly.

The art is replete with various prior art references related to numerous seal designed adaptable to retain and seal oil or grease in a predetermined location for lubrication the shaft. These prior art references include and are not limited to U.S. Pat. No. 4,501,431 to Peisker et al., U.S. Pat. No. 4,667,968 to Nash et al., U.S. Pat. No. 4,969,653 to Breen, U.S. Pat. No. 6,213,476 to Chandler et al., U.S. Pat. No. 6,620,361 to Longtin et al., and U.S. Pat. No. 6,736,404 to Shuster.

The U.S. Pat. No. 4,501,431 to Peisker et al., teaches a seal assembly including a casing unit, a resinous sealing ring unit, which is secured to the portion of the casing unit by an annular elastomeric bonding and a locating collar. A seal ring includes an active surface and a reverse surface. A single spiral groove or multiple grooves are formed along the active surface of the inner diameter portion of the ring. These grooves are hydrodynamic pumping elements whose general nature of operation is known to those skilled in the oil seal art.

The seal assembly taught by the U.S. Pat. No. 4,501,431 to Peisker et al. has several problems. The hydrodynamic features, such as spirals, are formed into the wafer portion of the seal, which contacts with the countersurface, i.e. the rotatable shaft. The location of the spirals or grooves results in clogging of these spirals or grooves with carbonized oil thereby reducing the lifespan of the seal assembly. Another problem is static leakage of oil through these spirals or grooves.

The U.S. Pat. No. 4,969,653 to Breen teaches a seal unit including a casing unit and an annular seal body portion extending to a flexible neck portion nearest the anchored portion of the seal body. The remainder of the seal body includes a primary seal lip and a secondary seal lip. The seal body includes a series of hydrodynamic groove configurations in the form of a single spiral groove hydrodynamically formed in the seal body. These grooves function as hydrodynamic pumping elements.

Similar to the seal assembly taught by the U.S. Pat. No. 4,501,431 to Peisker et al., the seal assembly taught by the U.S. Pat. No. 4,969,653 to Breen presents the same problems. The hydrodynamic features, such as grooves, are formed into portion of the seal which contacts with the countersurface, i.e. the rotatable shaft, thereby resulting in clogging of these grooves with oil or other lubricant, which reduces of the lifespan of the seal assembly and results in static leakage of oil through these grooves.

Hence, there is a need for an improved fluid seals and methods to eliminate problems associated with prior art designs such as static leakage of oil, clogging up the seals with carbonized oil that negatively impact lifecycle of the fluid seals. The inventive concept as set forth further below improves the aforementioned prior art systems and methods.

### SUMMARY OF THE INVENTION

A fluid seals assembly (the assembly) of the present invention has numerous applications including and not limited to sealing vehicular engine crankshafts, transmission shafts, bearing lubrication systems, compressor shaft support assemblies, and the like. The assembly is disposed between an outer surface, i.e. a housing or an engine block or any other part that requires application of the assembly and a rotatable member, such as, for example a shaft, wherein the assembly circumscribes the shaft and lubricated the shaft as the same rotates around the axis. The seal assembly includes a generally annular sealing member having a central portion and two axially-spaced apart side portions each extending generally radially from the central portion to define a generally annular groove. The seal assembly further includes first and second leg portions having a free end sealingly engageable with one of the shaft and the housing.

A generally annular support member is disposed within the annular groove and is configured to retain the central portion of the sealing member disposed generally against the other one of the shaft and the housing, formed with opposing inner and outer circumferential surfaces and a generally annular groove extending into one of the inner and outer circumferential surfaces, the sealing member central portion being disposed at least partially within the annular groove and the other one of the support member inner and outer surfaces being sealingly engaged with the other one of the shaft and the housing.

An advantage of the present invention is to provide an improved fluid seal assembly that eliminated problems associated with prior art designs such as static leakage of oil, clogging up the spirals with carbonized oil that negatively impact lifecycle of the fluid seals.

Another advantage of the present invention is to provide the fluid seal assembly that does not require molding.

Still another advantage of the present invention is to provide the fluid seal assembly that is cost effective in manufacturing and will lower cost of product.

Still another advantage of the present invention is to provide the fluid seal assembly design that allows more efficient process automation.

Still another advantage of the present invention is to provide the fluid seal assembly design that reduces waste of rubber materials.

Still another advantage of the present invention is to provide the fluid seal assembly design that does not require bond between structural member, i.e. support member and a rubber, i.e. a sealing member.

Still another advantage of the present invention is to provide the fluid seal assembly design that does not require any finishing procedures, other that assembly of the support member, the sealing member, disposed between the shaft and the housing.

Still another advantage of the present invention is to provide a new assembly seal, wherein a sealing lip is produced very inexpensively from a thin walled elastomeric tubing, which is cut to length and installed onto the outer diameter of the support member and then into an inner diameter of the housing.

Other advantages and meritorious features of this invention will be more fully understood from the following description of the preferred embodiment, the appended claims, and the drawings; a brief description of which follows.

### BRIEF DESCRIPTION OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings. Other advantages of the present invention will be readily appreciated as the same becomes better understood by reference to the following detailed description when considered in connection with the accompanying drawings wherein:

FIG. 1 illustrates a cross sectional view of a fluid seal assembly (the seal assembly) circumscribing a rotatable shaft and disposed between the shaft and a counter surface, i.e. a housing;

FIG. 2 illustrates a cross sectional view of the seal assembly of FIG. 1;

FIG. 3 illustrates an exploded view of the seal assembly;

FIG. 4 illustrates a cross sectional view of a first alternative embodiment of the seal assembly;

FIG. 5 illustrates a cross sectional view of a second alternative embodiment of the seal assembly; and

FIG. 6 illustrates a cross sectional view of a third alternative embodiment of the seal assembly.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

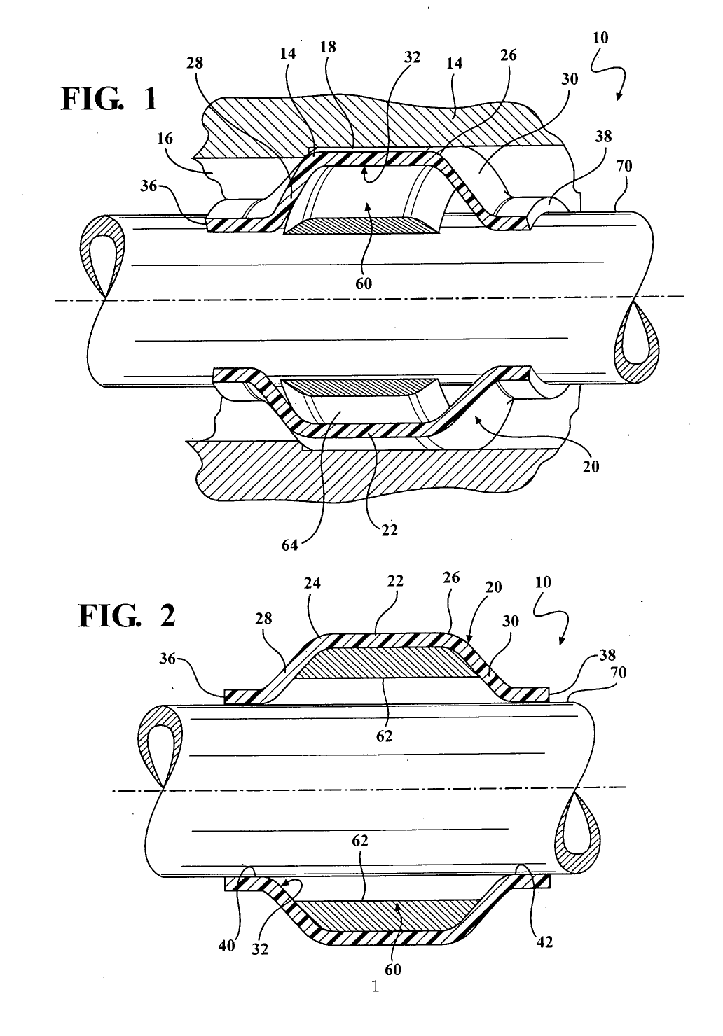

Referring now to the drawings in detail, wherein like numbers are used to indicate like elements throughout, a fluid seal assembly (the assembly) of the present invention is generally shown at 10 in FIGS. 1, 2, and 4 through 6. The assembly 10 has numerous applications including and not limited to sealing vehicular engine crankshafts, transmission shafts, bearing lubrication systems, compressor shaft support assemblies, and the like, without limiting the scope of the present invention. FIGS. 1, 4, 5, and 6 illustrate only one example, wherein the assembly 10 is disposed between a counterpart, such as a rotary shaft 12 rotatable about a central axis A and a surface, such as a housing 14 presenting inner wall or surface 16 defining a bore 18. Those skilled in the mechanical art will appreciate that the shaft 12 and the housing 14 are shown for exemplary purposes only and are not intended to limit the scope of the present invention.

The assembly 10 is designed for sealing a space between the housing 14 and the rotary shaft 12 rotatable about the central axis A and disposed at least partially within the housing 14 and providing leakage protection. The assembly 10 includes a generally annular sealing member (the sealing member), generally indicated at 20 having a central portion 22 with opposing axial ends 24 and 26. The sealing member 20 includes first and second leg portions 28 and 30 each extending generally radially from the opposing axial ends 24 and 26 of the central portion 22 so as to define a generally annular groove, generally indicated at 32, between the first and second leg portions 28 and 30. Each of the first and second leg portions 28 and 30 presents an inner end 36, 38 extending generally parallel to the central axis A. Each inner end 36, 38 further presents a first sealing surface 40 and a second sealing surface 42 being axially spaced apart and sealingly engageable with an outer surface 44 of the rotary shaft 12. The generally annual sealing member 20 is formed of a generally flexible material, such as elastomer, a resin, and any other elastomeric material without limiting the scope of the present invention. The annular sealing member 20 has generally C-shaped axial cross-section, as best shown in FIG. 2.

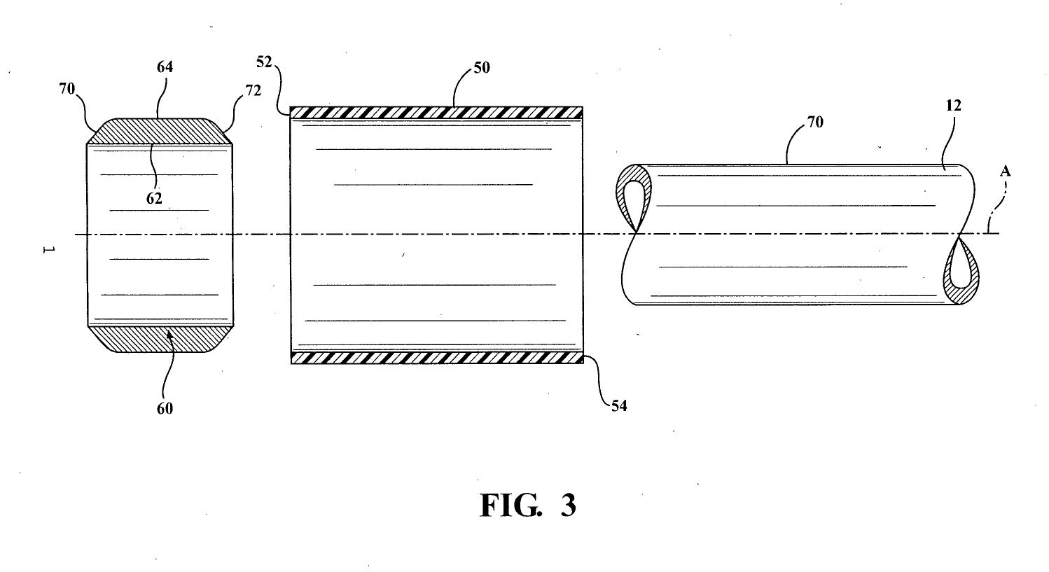

As best illustrated on FIG. 3, the generally annual sealing member 20 is formed of an elongated body 50 having opposing axial ends 52 and 54, a body being bended into a generally circular shape and the opposing axial ends 52 and 54 being attached together. The body 50 is formed as an extrusion.

The assembly 10 further includes an annular support member, generally indicated at 60. The support member 60 is disposed within the generally annular groove 32 and is configured to retain the central portion 22 disposed generally about the rotary shaft 12 and engaged by the bore 18 with the first and second leg portions 28 and 30 and the central portion 22 engaging the annular support member 50 with the first sealing surface 40 and the second sealing surface 42 providing leakage protection as the rotary shaft 12 rotates around the central axis A and relative the housing 14.

The annular support member 60 is formed of a generally rigid material. The generally annular support member 60 includes inner and outer circumferential surfaces 62 and 64 and inclined side walls 68 and 70, as best shown in FIG. 3, to mate with the first and second leg portions 28 and 30. The outer circumferential surface 64 engages the central portion 22 as the generally annual sealing member 20 is disposed against the inner wall 16 of the housing 14. As best shown in FIGS. 1 and 2, the annular support member 60 has a generally rectangular axial cross-section

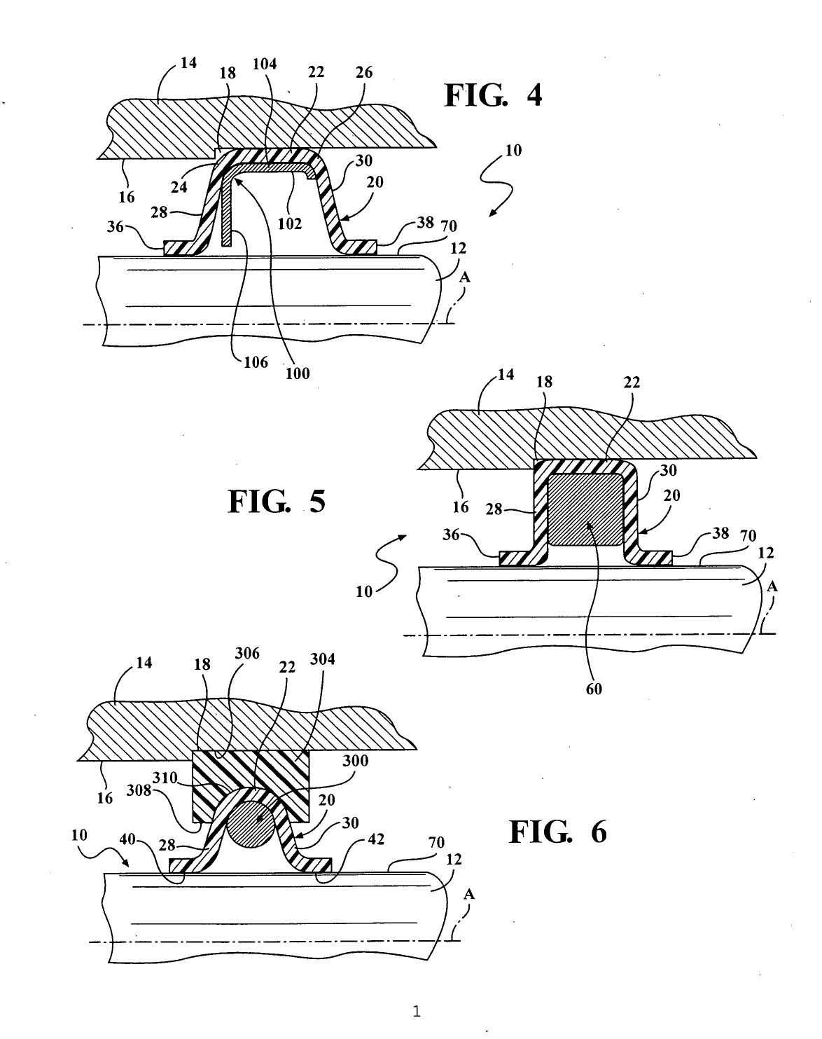

Alluding to the above and without limiting the scope of the present invention, the annular support member 20 includes different embodiments. A first alternative embodiment is generally indicated at 100 in FIG. 4, wherein the annular support member has a L-shaped cross section 102 presenting a side portion 104 engaging and supporting the central portion 20 thereby located inside the generally annular groove 32 and a radial flange 106 extending from the side portion 104 and positioned generally perpendicular to the central axis A and partially contacting at least one of said first leg portion 28 and the second leg portion 30. The support member 100 is formed from any rigid polymeric or metallic material without limiting the scope of the present invention.

FIG. 5 shows yet another, second alternative embodiment of the support member, generally indicated at 200, having a square cross section. The support member 200 is formed from any rigid polymeric or metallic material without limiting the scope of the present invention.

FIG. 6, shows yet another, i.e. a third alternative embodiment of the present invention, generally shown at 300, wherein the annular support member 302 has a circular cross section, such as, for example, a wire. The seal assembly 10, as illustrated in FIG. 6, includes a retaining element 304 defining an inner surface 306 and an outer surface 308. The outer surface 308 of the retaining element 304 is engaged, i.e. press fitted or connected to the bore 18 of the inner surface 18 of the housing 14. The inner surface 306 defines an inner groove 310 engaging the central portion 20 holding the annular support member 302 having the circular cross section. The central portion 20 is partially sandwiched between the annular support member 302 and the inner groove 310. The retaining element 304 is formed from at least one of a rigid polymer and a metallic material without limiting the scope of the present invention.

Referring back to FIGS. 1 and 3, after the generally annual sealing member 20 is formed of the elongated body 50 having opposing axial ends 52 and 54, and the body is bended into a generally circular shape and the opposing axial ends 52 and 54 being attached together, the support member 60 is inserted into the body 50. After the first and second leg portions 28 and 30 of the generally annular sealing member 20 are each deflectable from a radially inner position when the generally annular sealing member 20 is nonengaged with the rotary shaft 12 and a radially outer position, as shown in FIG. 2, when the generally annular sealing member 20 is engaged with the rotary shaft 12, the generally annular sealing member 20 is configured to bias each of the first leg portion 28 and the second leg portion 30 generally radially inwardly toward the central axis A to generate contact pressure with the outer surface 70 of the rotary shaft 12 when the seal assembly 10 is mounted on the rotary shaft 12.

An advantage of the present invention is to provide an improved fluid seal assembly 10 that eliminated problems associated with prior art designs such as static leakage of oil, clogging up the spirals with carbonized oil that negatively impact lifecycle of the fluid seals. The seal assembly 10 does not require molding and is cost effective in manufacturing thereby lowering cost of product. The manufacturing process of the seal assembly 10 reduces waste of rubber materials and does not require bond between structural member, i.e. support member and a rubber, i.e. a sealing member.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

1. A seal assembly for sealing a space between a housing and a rotary shaft rotatable about a central axis and disposed at least partially within the housing for providing leakage protection, the housing having an inner surface defining a bore, the seal assembly comprising:
a generally annular sealing member having a central portion with opposing axial ends and first and second leg portions each extending generally radially from said opposing axial ends of said central portion so as to define a generally annular groove between said first and second leg portions, each one of said first and second leg portions having an inner end extending generally parallel to said central axis each presenting a first sealing surface and a second sealing surface being axially spaced apart and sealingly engageable with an outer surface of the rotary shaft; and
an annular support member disposed within said generally annular groove and configured to retain said central portion disposed generally about the rotary shaft and engaged by the bore with said first and second leg portions and said central portion engaging said annular support member with said first sealing surface and said second sealing surface providing leakage protection as the rotary shaft rotates around said central axis and relative the housing.

2. The seal assembly as set forth in claim 1 wherein said generally annual sealing member is formed of a generally flexible material and said annular support member is formed of a generally rigid material.

3. The seal assembly as set forth in claim 2 wherein said generally annular sealing member is formed of an elastomeric material and said annular support member is formed of one of a rigid polymer and a metallic material.

4. The seal assembly as set forth in claim 1 wherein said generally annual sealing member is formed of an elongated body having opposing axial ends, said elongated body being bended into a generally circular shape and said opposing ends being attached together.

5. The seal assembly as set forth in claim 4 wherein said body is formed as an extrusion.

6. The seal assembly as set forth in claim 1 wherein said generally annular support member includes inner and outer circumferential surfaces and inclined side walls to mate with said first and second leg portions and said outer circumferential surface engage with said central portion, said generally annual sealing member being disposed against the inner surface of the housing and said generally annular sealing member.

7. The seal assembly as set forth in claim 1 wherein said generally annular sealing member has generally C-shaped axial cross-section and said annular support member has a generally rectangular axial cross-section.

8. The seal assembly as set forth in claim 1 wherein said first and second leg portions of said generally annular sealing member are each deflectable from a radially inner position when said generally annular sealing member is nonengaged with the rotary shaft and a radially outer position when said generally annular sealing member is engaged with the rotary shaft, said generally annular sealing member being configured to bias each of said first leg and said second leg generally radially inwardly toward the central axis to generate contact pressure with the outer surface of the rotary shaft when the seal assembly is mounted on the rotary shaft.

9. The seal assembly as set forth in claim 1 wherein said annular support member has a square cross section.

10. The seal assembly as set forth in claim 1 wherein said annular support member has a L-shaped cross section presenting a side portion engaging and supporting said central portion thereby located inside said generally annular groove and a radial flange extending from said side portion and positioned generally perpendicular to the central axis and partially contacting at least one of said first leg portion and said second leg portion.

11. The seal assembly as set forth in claim 1 wherein said annular support member has a circular cross section.

12. The seal assembly as set forth in claim 11 including a retaining element defining an inner surface and an outer surface, said outer surface of said retaining element engaged within the bore of the inner surface of the housing and said inner surface defining an inner groove engaging said central portion thereby holding said annular support member having said circular cross section whereby said central portion being partially sandwiched between said annular support member and said inner groove.

13. The seal assembly as set forth in claim 12 wherein said retaining element is formed from at least one of a rigid polymer and a metallic material.

14. A method of forming a seal assembly to seal a space between a housing having a bore defined in an inner surface of the housing and a rotary shaft rotatable about a central axis, the method comprising the steps of:
extruding an elongated sealing member having a central portion with opposing axial ends and first and second leg portions each extending generally radially from the opposing axial ends and further to a first sealing surface and a second sealing surface to define a generally annular groove between the first and second leg portions;
bending the elongated sealing member into a generally circular shape;
forming an annular support member to be disposed within the generally annular groove to retain the central portion disposed generally about the rotary shaft and engaged by the bore; and
installing the annular support member within the sealing member groove and being engaged by the first leg portion and the second leg portion and the central portion to press the first sealing surface and the second sealing surface against the rotary shaft to provide leakage protection as the rotary shaft rotates around the central axis and relative the housing.

15. The method as set forth in claim 14 wherein the step of extruding an elongated sealing member is further defined by forming the elongated sealing member from a generally flexible elastomeric material.

16. The method as set forth in claim 14 including the step of forming the annular support member from a generally rigid metallic material.

17. The method as set forth in claim 14 including the step of forming the generally annular support member having inner and outer circumferential surfaces and inclined side walls to mate with the first and second leg portions and the outer circumferential surfaces engaging the central portion.

18. The method as set forth in claim 14 including the step of forming the generally annular sealing member having generally C-shaped axial cross-section and the annular support member having generally rectangular axial cross-section.

19. The method as set forth in claim 14 including the step of deflecting each of the first and second leg portions of the generally annular sealing member from a radially inner position when the generally annular sealing member is nonengaged with the rotary shaft and a radially outer position when the generally annular sealing member is engaged with the rotary shaft, the generally annular sealing member being configured to bias each of the first leg and the second leg generally radially inwardly toward the central axis to generate contact pressure with the outer surface of the rotary shaft when the seal assembly is mounted on the rotary shaft.

20. The method as set forth in claim 14 wherein the annular support member is formed having a square cross section.

21. The method as set forth in claim 14 wherein the annular support member is formed with a L-shaped cross section to include a side portion engaging and supporting the central portion to locate inside the generally annular groove and a radial flange extending from the side portion and positioned generally perpendicular to the central axis and partially contacting at least one of the first leg portion and the second leg portion.

22. The method as set forth in claim 14 including the step of forming a retaining element defining an inner surface and an outer surface engaged within the bore of the inner surface of the housing and the inner surface further defining an inner groove engaging the central portion holding the annular support member, the central portion being partially sandwiched between the annular support member and the inner groove.

23. A seal assembly for sealing a space between a housing and a rotary shaft disposed at least partially within the housing, the housing having an inner surface defining a bore, said seal assembly comprising:
a generally annular sealing member having a central portion and two axially-spaced apart sidewall portions each extending generally radially from the central portion so as to define a generally annular groove, each two sidewall portions being sealingly engageable with one of the rotary shaft and the housing; and
a generally annular support member, the support member being one of: disposed within the sealing member groove and configured to retain the central portion disposed generally against the other one of the shaft and the housing; formed with opposing inner and outer circumferential surfaces and a generally annular groove extending into one of the inner and outer circumferential surfaces, the sealing member central portion being disposed at least partially within the annular groove and the other one of the support member inner and outer surfaces being sealingly engaged with the other one of the shaft and the housing.

24. The seal assembly as recited in claim 23 wherein the sealing member central portion has opposing axial ends and each one of the two sidewall portions has a first radial end integrally formed with a separate axial end of the central portion, an opposing second radial end and a generally circumferential sealing surface proximal to the second radial end, each sealing surface being contactable with the shaft outer surface so as to form a seal interface.
